(19) United States
(12) Patent Application Publication
(10) Pub. No.: US 2012/0311119 A1
(43) Pub. Date: Dec. 6, 2012

(54) REMOTE MANAGEMENT METHOD AND REMOTE MANAGEMENT SYSTEM

(76) Inventors: Ping-Hung Chen, New Taipei City (TW); Li-Yu Yang, New Taipei City (TW); Fang-Wen Liao, New Taipei City (TW)

(21) Appl. No.: 13/220,655

(22) Filed: Aug. 29, 2011

(30) Foreign Application Priority Data
May 30, 2011 (TW) 100118918

(51) Int. Cl. G06F 15/173

(52) U.S. Cl. 709/223

(57) ABSTRACT

A remote management method includes steps of executing an operating system in a host device, wherein the operating system is a Microsoft Windows operating system with a remote desktop protocol, and a remote management program and a main application are installed in the host device; M of N user devices communicating with the host device by the remote desktop protocol and executing the main application in the host device, wherein N is a positive integer and M is a positive integer smaller than or equal to N; and a manager device communicating with the host device and executing the remote management program in the host device so as to manage using status of the M user devices while the M user devices execute the main application in the host device.

### BACKGROUND OF THE INVENTION

1. Field of the Invention

The invention relates to a remote management method and a remote management system and, more particularly, to a remote management method and a remote management system utilizing a remote management program for a manager to monitor and manage using status of users.

2. Description of the Prior Art

So far most of remote management techniques (e.g. cloud technique) usually use one special server to share resources among users. In other words, all of the users use resources of the same special server. Furthermore, the special server does not provide interactive function for the users and does not provide monitor function for a manager to monitor the users, such as functions of transmitting messages, sending applications to user end, monitoring desktop of specific user, terminating specific application executed by a user, and so on. Therefore, the conventional remote management technique has disadvantages described in the following.

1) It is necessary to establish a special server and the cost is high.

2) When a user uses resources of the server, there is no management program for a manager to monitor and manage the user.

3) There is no interactive function for users.

4) The manager cannot terminate resources, which are not allowed to be used by specific user (e.g. an application not allowed to be executed).

### SUMMARY OF THE INVENTION

The invention provides a remote management method and a remote management system utilizing a remote management program for a manager to monitor and manage using status of users, so as to solve the aforesaid problems.

According to the claimed invention, a remote management method comprises executing an operating system in a host device, wherein the operating system is a Microsoft Windows operating system with a remote desktop protocol, and a remote management program and a main application are installed in the host device; M of N user devices communicating with the host device by the remote desktop protocol and executing the main application in the host device, wherein N is a positive integer and M is a positive integer smaller than or equal to N; and a manager device communicating with the host device and executing the remote management program in the host device so as to manage using status of the M user devices while the M user devices execute the main application in the host device.

According to the claimed invention, the remote management method further comprises the remote management program displaying a management screen on the manager device, wherein the management screen shows M user icons corresponding to the M user devices.

According to the claimed invention, the remote management method further comprises the manager device executing the remote management program in the host device so as to add, cancel or modify user accounts of the N user devices associated with the main application.

According to the claimed invention, the remote management method further comprises the manager device executing the remote management program in the host device so as to login or logout at least one of the M user devices from the main application.

According to the claimed invention, the remote management method further comprises the remote management program being triggered to login or logout at least one of the M user devices from the main application after a predetermined time.

According to the claimed invention, the remote management method further comprises the manager device executing the remote management program in the host device so as to transmit a message, a file and/or an accessory application from the host device to at least one of the M user devices.

According to the claimed invention, the remote management method further comprises if the accessory application is a desktop captured application, the desktop captured application capturing desktop image(s) of at least one of the M user devices and sending the desktop image(s) back to the host device for the manager device to access.

According to the claimed invention, the remote management method further comprises the desktop captured application updating the desktop image(s) of at least one of the M user devices stored in the host device every a predetermined time.

According to the claimed invention, the remote management method further comprises the manager device executing the remote management program in the host device so as to terminate an accessory application and/or a web page executed in the host device by at least one of the M user devices.

According to the claimed invention, the remote management method further comprises once a number of accessory applications executed in the host device by at least one of the M user devices exceed a predetermined value, the remote management program terminating an exceeding number of accessory applications.

According to the claimed invention, the remote management method further comprises once an executing time of the accessory application executed in the host device by at least one of the M user devices exceeds a predetermined value, the remote management program terminating the accessory application.

According to the claimed invention, the remote management method further comprises once the accessory application executed in the host device by at least one of the M user devices is not allowed to be executed, the remote management program terminating the accessory application.

According to the claimed invention, a remote management system comprises a host device for executing an operating system, wherein the operating system is a Microsoft Windows operating system with a remote desktop protocol, and a remote management program and a main application are installed in the host device; N user devices, M of N user devices communicating with the host device by the remote desktop protocol and executing the main application in the host device, wherein N is a positive integer and M is a positive integer smaller than or equal to N; and a manager device communicating with the host device and executing the remote management program in the host device so as to manage using status of the M user devices while the M user devices execute the main application in the host device.

As mentioned in the above, the remote management method and the remote management system of the invention utilize a remote management program for a manager to monitor and manage using status of users. The remote management program can provides the following functions.

1) Monitor function: the manager can monitor using status of users.

2) Connection management function: the manager can manage a number of users connected to the host device.

3) Account management function: the manager can establish individual account for different users.

4) Application termination function: the manager can terminate specific application, which is not allowed to be executed by specific user.

5) Communication function: the manager can transmit messages to specific user.

6) File/application transmitting function: the manager can transmit specific file or application to a desktop of specific user.

7) Bulletin board function: if one of the user devices is a digital signage, the manager can transmit specific document or message to the digital signage.

8) Multi-display output function: if the manager device comprises two display devices, the manager can utilize one display device to monitor using status of users and utilize the other display device to display specific file or message; if the manager device comprises a portable electronic device (e.g. flat computer), the manager can go ground and utilize the portable electronic device to control the host device in wireless, so as to monitor and manage using status of users.

Furthermore, the host device, which is used to install the remote management program, may be a server or a common desktop computer capable of executing Microsoft Windows operating system with a remote desktop protocol. Thus, the cost of establishing the host device of the invention is lower than the prior art. Each of the users can uses individual user device to connect the host device and possesses individual resource and desktop. Under specific using authority, the invention only has to install one main application in the host device and then all of the users can uses the main application in the host device. In other words, it is unnecessary to install the main application in each of the user devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a remote management system according to one embodiment of the invention.

FIG. 2 is a functional block diagram illustrating the remote management system shown in FIG. 1.

FIG. 3 is a flowchart showing a remote management method according to one embodiment of the invention.

FIG. 4 is a flowchart showing an account management function provided by the remote management program.

FIG. 5 is a flowchart showing a connection management function provided by the remote management program.

FIG. 6 is a flowchart showing a desktop management function provided by the remote management program.

FIG. 7 is a flowchart showing a process management function provided by the remote management program.

FIG. 8 is a schematic diagram illustrating a management screen displayed by the remote management program.

### DETAILED DESCRIPTION

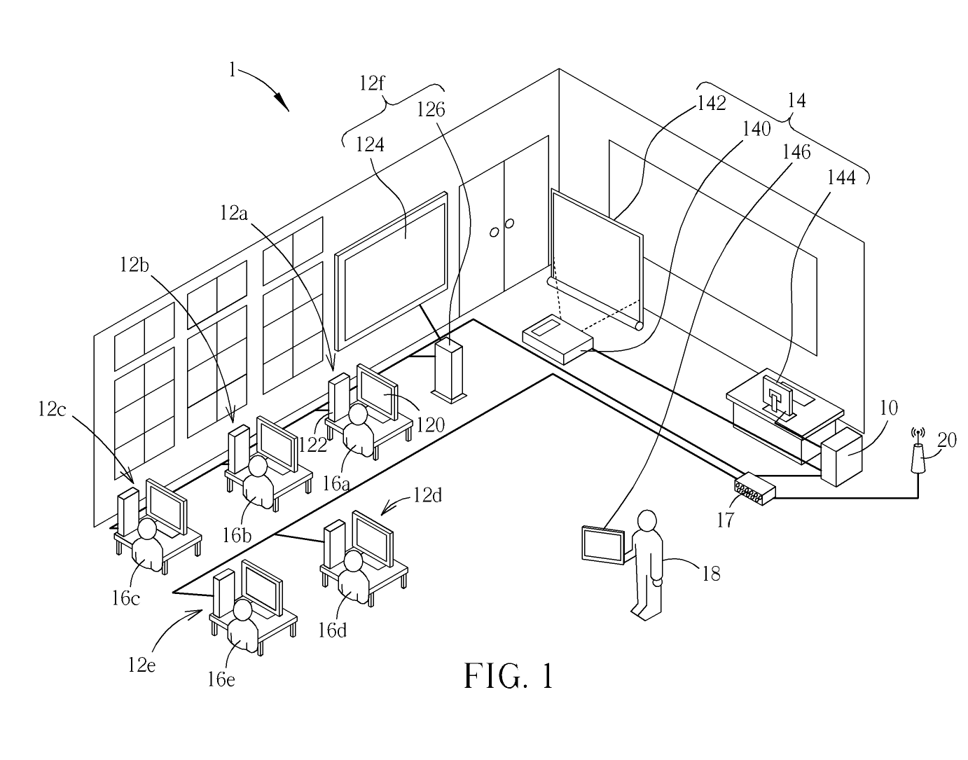

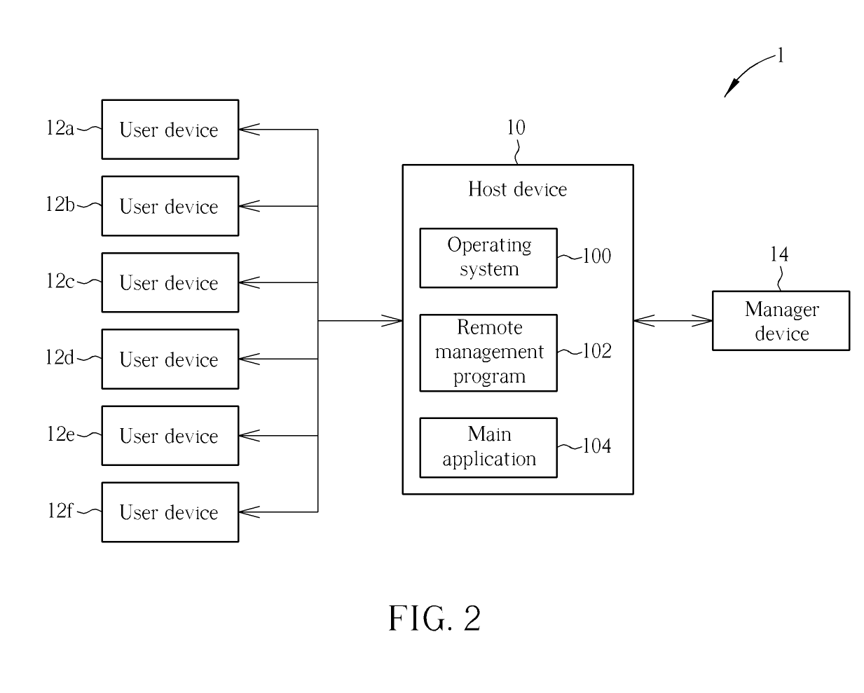

Referring to FIGS. 1 and 2, FIG. 1 is a schematic diagram illustrating a remote management system 1 according to one embodiment of the invention, and FIG. 2 is a functional block diagram illustrating the remote management system 1 shown in FIG. 1. As shown in FIG. 1, the remote management system 1 comprises a host device 10, N user devices 12a-12f and a manager device 14. In this embodiment, N is equal to, but not limited to, 6. In other words, N can be a positive integer. As shown in FIG. 2, the host device 10 is used for executing an operating system 100, wherein the operating system 100 is a Microsoft Windows operating system (e.g. Windows 2000, Windows XP, Windows 7, etc.) with a remote desktop protocol, and a remote management program 102 and a main application 104 (e.g. teaching application) are installed in the host device 10. It should be noted that the host device 10 may be a server or a common desktop computer capable of executing Microsoft Windows operating system with the remote desktop protocol. Thus, the cost of establishing the host device 10 of the invention is lower than the prior art.

In this embodiment, the user devices 12a-12e are provided for users 16a-16e respectively and each of the user devices 12a-12e comprises a display device 120 (e.g. liquid crystal display device) and a computer sharing device 122 (e.g. Ncomputing series), wherein each of the display devices 120 is electrically connected to one of the computer sharing devices 122 correspondingly, and each of the computer sharing devices 122 executes the operating system 100 as executed in the host device 10. The user device 12f may comprise a digital signage 124 and a signal processing device 126, wherein the digital signage 124 is electrically connected to the signal processing device 126. Furthermore, each of the computer sharing devices 122 and the signal processing device 126 can be connected to a router 17 by cables and the router 17 is connected to the host device 10, so that M of the six user devices 12a-12f can communicate with the host device 10 via the remote desktop protocol. In this embodiment, M is equal to, but not limited to, 6. In other words, M can be a positive integer smaller than or equal to N. It should be noted that each of the computer sharing devices 122 and the signal processing device 126 can also communicate with the host device 10 in wireless and it depends on practical applications.

In this embodiment, the manager device 14 is used for a manager 18 to monitor and manage using status of the user devices 12a-12f. As shown in FIG. 1, the manager device 14 may comprise a projector 120, a projecting screen 142, a display device 144 (e.g. liquid crystal display device) and a portable electronic device 146 (e.g. flat computer). The projector 140 and the display device 144 are electrically connected to the host device 10 so as to communicate with the host device 10. The portable electronic device 146 can communicate with the host device 10 in wireless via an access point (AP) 20, which is connected to the router 17. Accordingly, the manager 18 can monitor using status of the users 16a-16e by the display device 144 and broadcast specific file or message by the projector 140 and the projecting screen 142. Furthermore, the manager 18 can transmit specific document or message to the aforesaid signage 124 for the users 16a-16e. Moreover, the manager 18 can go around and control the host device 10 in wireless via the portable electronic device 146, so as to monitor and manage using status of the users 16a-16e.

It should be noted that the aforesaid user devices 12a-12f and manager device 14 are one embodiment for illustrating the features of the invention and the invention is not limited to the aforesaid embodiment. The user devices 12a-12f and the manager device 14 can be any possibly electronic devices, which are capable of communicating with the host device 10, can be operated by the users 16a-16e and the manager 18, and can display information for the users 16a-16e and the manager 18.

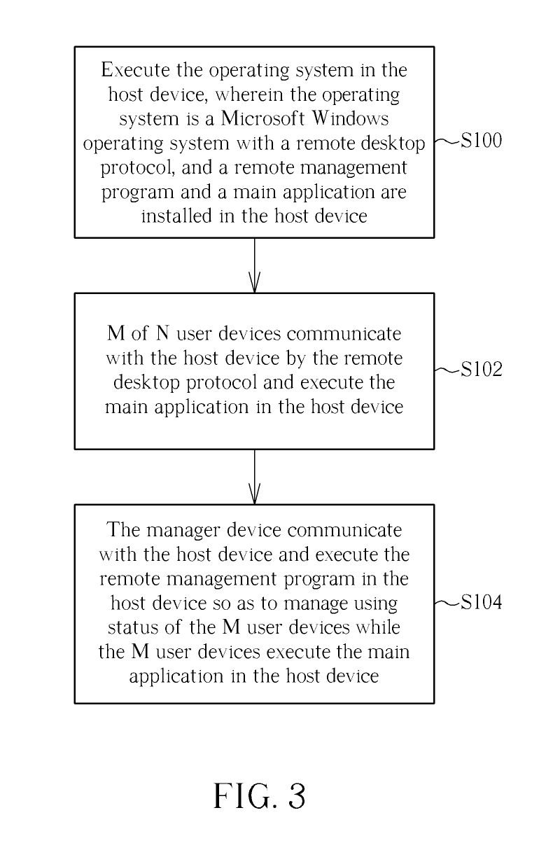

Referring to FIG. 3, FIG. 3 is a flowchart showing a remote management method according to one embodiment of the invention. The remote management method shown in FIG. 3 can be implemented by the remote management system 1 shown in FIGS. 1 and 2. First of all, step S100 is performed to execute the operating system 100 in the host device 10, wherein the operating system 100 is a Microsoft Windows operating system with a remote desktop protocol, and a remote management program 102 and a main application 104 are installed in the host device 10. Afterwards, M of N user devices 12a-12f communicate with the host device 10 by the remote desktop protocol and execute the main application 104 in the host device 10 (step S102), wherein N is a positive integer and M is a positive integer smaller than or equal to N. Then, the manager device 14 communicate with the host device 10 and execute the remote management program 102 in the host device 10 so as to manage using status of the M user devices 12a-12f while the M user devices 12a-12f execute the main application 104 in the host device 10 (step S104).

The remote management program 102 of the invention can provide various monitor and management functions for the manager 18 and those functions are described in the following.

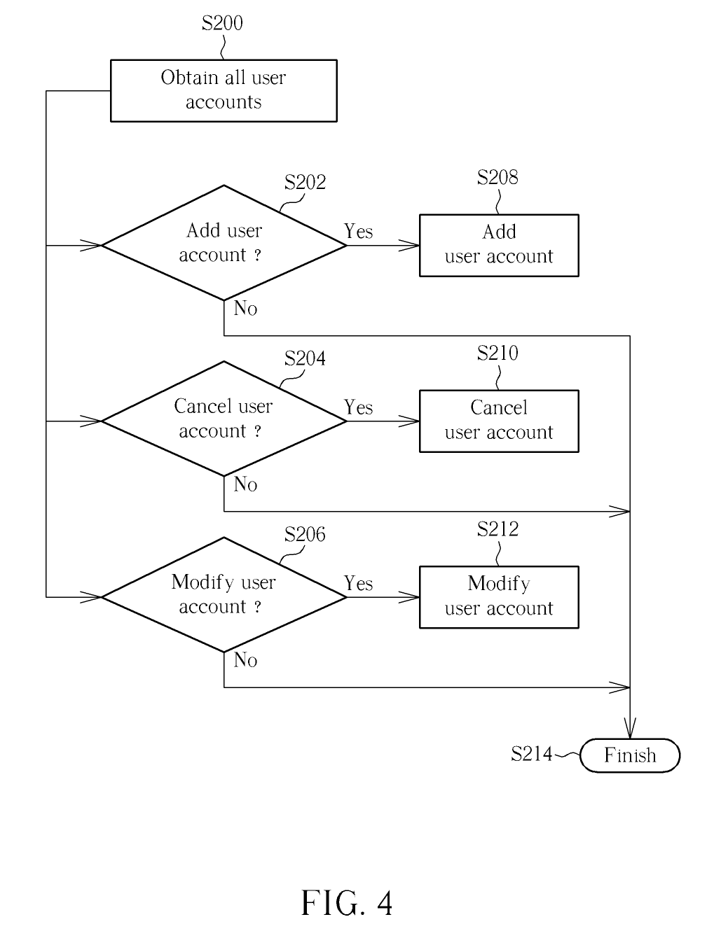

Referring to FIG. 4, FIG. 4 is a flowchart showing an account management function provided by the remote management program 102. First of all, in step S200, the manager 18 uses the manager device 14 to execute an account management function of the remote management program 102 in the host device 10 so as to obtain all user accounts. Afterward, in steps S202, S204 and S206, the manager 18 can decide whether to add, cancel or modify user accounts of the user devices 12a-12e of the users 16a-16e associated with the main application 104. If the manager 18 wants to add user account, step S208 is then performed to add user account; if the manager 18 wants to cancel user account, step S210 is then performed to cancel user account; if the manager 18 wants to modify user account, step S212 is then performed to modify user account; if the manager 18 does not add, cancel or modify user account, step S214 is then performed to finish the account management function. Accordingly, the manager 18 can add, cancel or modify user accounts in the host device 10 for different users 16a-16e. In practical applications, the account management function can be implemented by an Application Programming Interface (API), namely WTSEnumerationSession, of Microsoft Windows operating system.

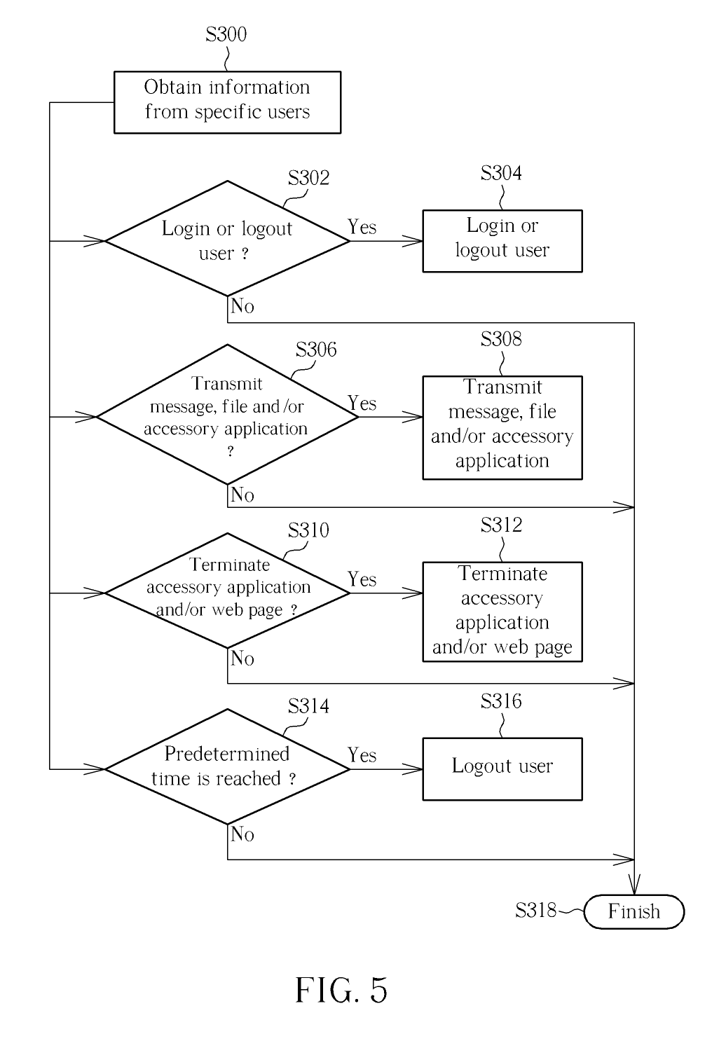

Referring to FIG. 5, FIG. 5 is a flowchart showing a connection management function provided by the remote management program 102. First all, in step S300, the manager 18 uses the manager device 14 to execute a connection management function of the remote management program 102 in the host device 10 so as to obtain information from specific users 16a-16e. Afterward, the manager 18 can decide whether to login or logout at least one of the user devices 12a-12e of the users 16a-16e from the main application 104 (step S302). If it is YES in step S302, step S304 is then performed to login or logout user, otherwise step S318 is then performed to finish the connection management function. Accordingly, the manager 18 can manage a specific number of user devices connected to the host device 10. Furthermore, the manager 18 can decide whether to transmit a message, a file and/or an accessory application to at least one of the user devices 12a-12f (step S306). If it is YES in step S306, step S308 is then performed to transmit message, file and/or accessory application, otherwise step S318 is then performed to finish the connection management function. Accordingly, the manager 18 can communicate with the users by transmitting message, file and/or accessory application. Still further, the manager 18 can decide whether to terminate an accessory application (e.g. paint) and/or a web page (e.g. sexual web page) executed in the host device 10 by at least one of the user devices 12a-12f (step S310). If it is YES in step S310, step S312 is then performed to terminate accessory application and/or web page, otherwise step S318 is then performed to finish the connection management function. Accordingly, the manager 18 can terminate specific accessory application and/or web page, which is not allowed to be executed by specific user. Moreover, after a predetermined time (e.g. ten minutes), the remote management program 102 can be triggered automatically to logout at least one of the user devices 12a-12e of the users 16a-16e from the main application 104, wherein step S314 is performed to determine whether the predetermined time is reached. If it is YES in step S314, step S316 is then performed to logout user, otherwise step S318 is then performed to finish the connection management function. In practical applications, the connection management function can be implemented by an API, namely WTSLogoffSession, of Microsoft Windows operating system.

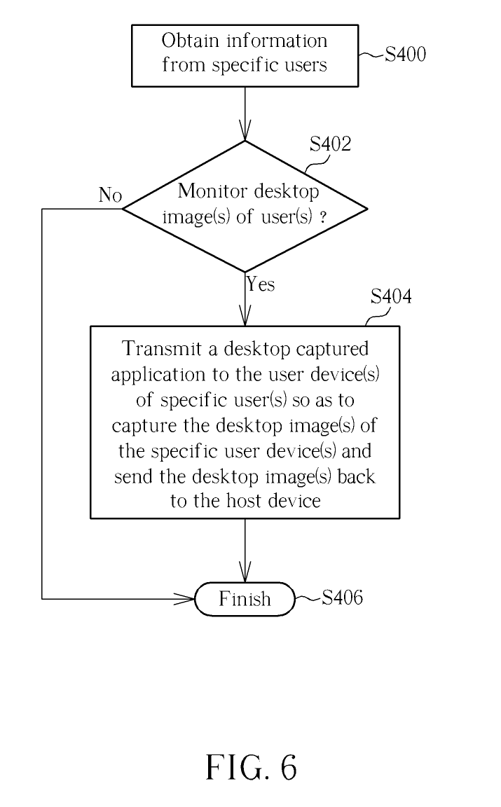

Referring to FIG. 6, FIG. 6 is a flowchart showing a desktop management function provided by the remote management program 102. First of all, in step S400, the manager 18 uses the manager device 14 to execute a desktop management function of the remote management program 102 in the host device 10 so as to obtain information from specific users 16a-16e. Afterward, the manager can decide whether to monitor desktop image (s) of at least one of the user devices 12a-12e of the users 16a-16e (step S402). If it is YES in step S402, step S404 is then performed to execute the remote management program 102 to transmit a desktop captured application to the user device(s) of specific user(s). At this time, the desktop captured application will capture the desktop image(s) of the specific user device(s) and send the desktop image(s) back to the host device 10. The manager 18 can use the manager device 14 to access the desktop image(s) of the specific user device(s) from the host device 10 so as to display the desktop image(s) of the specific user device(s) on the display device of the manager device 14 for purpose of monitor. In this embodiment, the desktop captured application may update the desktop image(s) of the specific user device(s) stored in the host device 10 every a predetermined time (e.g. five seconds), such that the manager 18 can monitor the last using status of specific user any time. If the manager 18 decides not to monitor the users, step S406 is performed to finish the desktop management function. In practical applications, the desktop management function can be implemented by an API, namely CreateCompatibleBitmap, of Microsoft Windows operating system.

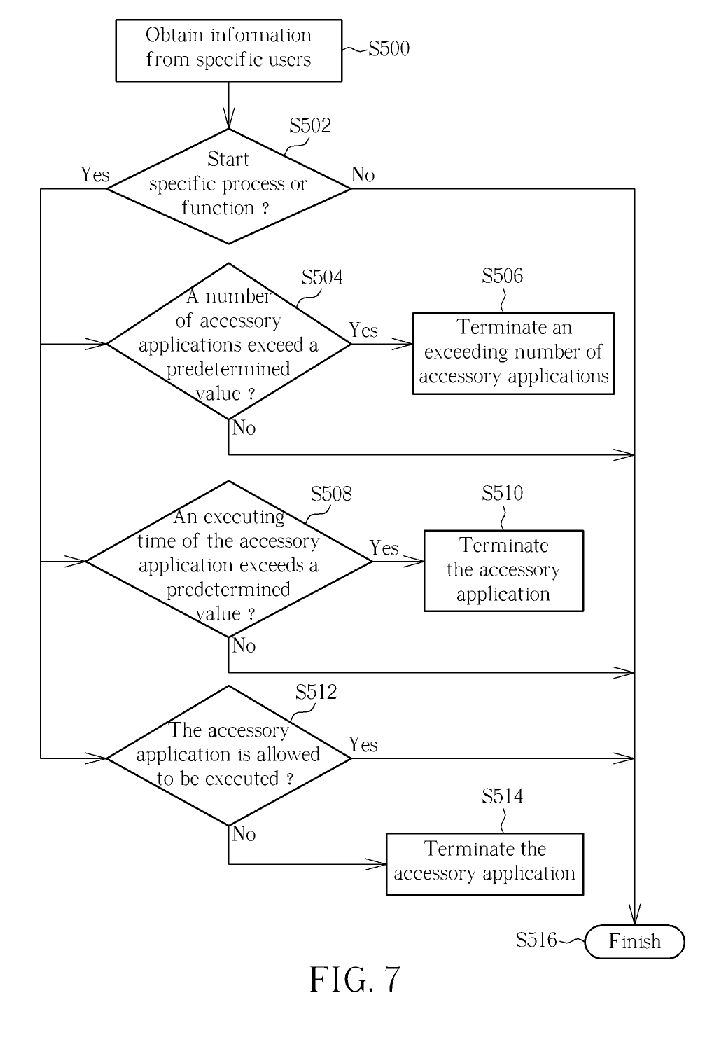

Referring to FIG. 7, FIG. 7 is a flowchart showing a process management function provided by the remote management program 102. First of all, in step S500, the manager 18 uses the manager device 14 to execute the remote management program 102 in the host device 10 so as to obtain information from specific users 16a-16e. After executing the remote management program 102, a process management function of the remote management program 102 is executed to determine whether to start specific process or function (step S502). If it is YES in step S502, steps S504, S508 and S512 are then selectively performed, otherwise step S516 is then performed to finish the process management function. In step S504, the remote management program 102 determines whether a number of accessory applications executed in the host device 10 by at least one of the user devices 12a-12e exceed a predetermined value (e.g. ten). If it is YES in step S504, step S506 is then performed to terminate an exceeding number of accessory applications, otherwise step S516 is then performed to finish the process management function. In step S508, the remote management program 102 determines whether an executing time of the accessory application executed in the host device 10 by at least one of the user devices 12a-12e exceeds a predetermined value (e.g. five minutes). If it is YES in step S508, step S510 is then performed to terminate the accessory application, otherwise step S516 is then performed to finish the process management function. In step S512, the remote management program 102 determines whether the accessory application executed in the host device 10 by at least one of the user devices 12a-12e is allowed to be executed. If it is YES in step S512, step S516 is then performed to finish the process management function, otherwise step S514 is performed to terminate the accessory application. In practical applications, the process management function can be implemented by an API, namely WTSTerminateProcess, of Microsoft Windows operating system.

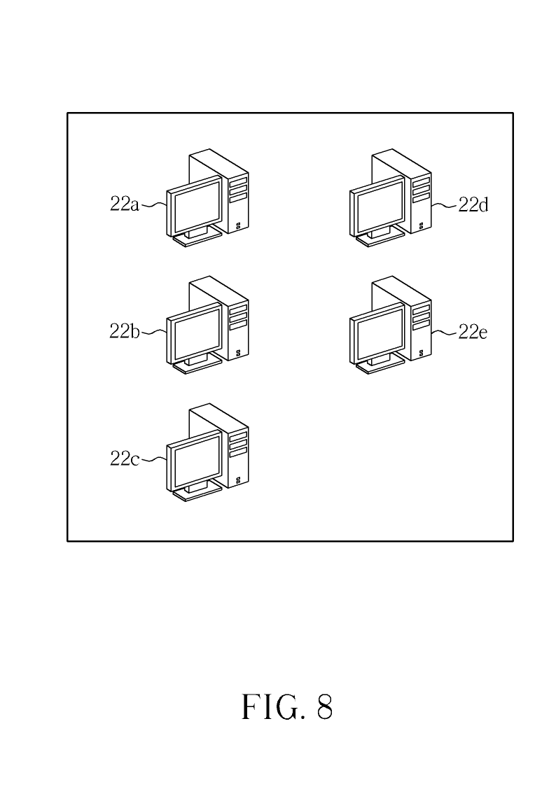

Referring to FIG. 8, FIG. 8 is a schematic diagram illustrating a management screen displayed by the remote management program. When the manager 18 uses the manager device 14 to execute the remote management program 102 in the host device 14, the remote management program 102 displays a management screen (shown in FIG. 8) on the display device 144 and/or the portable electronic device 146 of the manager device 14 (shown in FIG. 1). As shown in FIG. 8, the management screen shows user icons 22a-22e corresponding to the user devices 12a-12e. In practical applications, the management screen can be implemented by an API, namely WTSEnumerationSession, of Microsoft Windows operating system. The manager 18 can select any one of the user icons 22a-22e in the management screen so as to monitor and manage using status of the user devices 12a-12e.

Compared to the prior art, the remote management method and the remote management system of the invention utilize a remote management program for a manager to monitor and manage using status of users. The remote management program can provides the following functions.

1) Monitor function: the manager can monitor using status of users.

2) Connection management function: the manager can manage a number of users connected to the host device.

3) Account management function: the manager can establish individual account for different users.

4) Application termination function: the manager can terminate specific application, which is not allowed to be executed by specific user.

5) Communication function: the manager can transmit messages to specific user.

6) File/application transmitting function: the manager can transmit specific file or application to a desktop of specific user.

7) Bulletin board function: if one of the user devices is a digital signage, the manager can transmit specific document or message to the digital signage.

8) Multi-display output function: if the manager device comprises two display devices, the manager can utilize one display device to monitor using status of users and utilize the other display device to display specific file or message; if the manager device comprises a portable electronic device (e.g. flat computer), the manager can go ground and utilize the portable electronic device to control the host device in wireless, so as to monitor and manage using status of users.

Furthermore, the host device, which is used to install the remote management program, may be a server or a common desktop computer capable of executing a Microsoft Windows operating system with a remote desktop protocol. Thus, the cost of establishing the host device of the invention is lower than the prior art. Each of the users can uses individual user device to connect the host device and possesses individual resource and desktop. Under specific using authority, the invention only has to install one main application in the host device and then all of the users can uses the main application in the host device. In other words, it is unnecessary to install the main application in each of the user devices.

Those skilled in the art will readily observe that numerous modifications and alterations of the device and method may be made while retaining the teachings of the invention.

What is claimed is:

1. A remote management method comprising:
executing an operating system in a host device, wherein the operating system is a Microsoft Windows operating system with a remote desktop protocol, and a remote management program and a main application are installed in the host device;
M of N user devices communicating with the host device by the remote desktop protocol and executing the main application in the host device, wherein N is a positive integer and M is a positive integer smaller than or equal to N; and
a manager device communicating with the host device and executing the remote management program in the host device so as to manage using status of the M user devices while the M user devices execute the main application in the host device.

2. The remote management method of claim 1, further comprising:
the remote management program displaying a management screen on the manager device, wherein the management screen shows M user icons corresponding to the M user devices.

3. The remote management method of claim 1, further comprising:
the manager device executing the remote management program in the host device so as to add, cancel or modify user accounts of the N user devices associated with the main application.

4. The remote management method of claim 1, further comprising:
the manager device executing the remote management program in the host device so as to login or logout at least one of the M user devices from the main application.

5. The remote management method of claim 4, further comprising:
the remote management program being triggered to login or logout at least one of the M user devices from the main application after a predetermined time.

6. The remote management method of claim 1, further comprising:
the manager device executing the remote management program in the host device so as to transmit a message, a file and/or an accessory application from the host device to at least one of the M user devices.

7. The remote management method of claim 6, further comprising:
if the accessory application is a desktop captured application, the desktop captured application capturing desktop image (s) of at least one of the M user devices and sending the desktop image(s) back to the host device for the manager device to access.

8. The remote management method of claim 7, further comprising:
the desktop captured application updating the desktop image (s) of at least one of the M user devices stored in the host device every a predetermined time.

9. The remote management method of claim 1, further comprising:
the manager device executing the remote management program in the host device so as to terminate an accessory application and/or a web page executed in the host device by at least one of the M user devices.

10. The remote management method of claim 9, further comprising:
once a number of accessory applications executed in the host device by at least one of the M user devices exceed a predetermined value, the remote management program terminating an exceeding number of accessory applications.

11. The remote management method of claim 9, further comprising:
once an executing time of the accessory application executed in the host device by at least one of the M user devices exceeds a predetermined value, the remote management program terminating the accessory application.

12. The remote management method of claim 9, further comprising:
once the accessory application executed in the host device by at least one of the M user devices is not allowed to be executed, the remote management program terminating the accessory application.

13. A remote management system comprising:
a host device for executing an operating system, wherein the operating system is a Microsoft Windows operating system with a remote desktop protocol, and a remote management program and a main application are installed in the host device;
N user devices, M of N user devices communicating with the host device by the remote desktop protocol and executing the main application in the host device, wherein N is a positive integer and M is a positive integer smaller than or equal to N; and
a manager device communicating with the host device and executing the remote management program in the host device so as to manage using status of the M user devices while the M user devices execute the main application in the host device.

14. The remote management system of claim 13, wherein the remote management program displays a management screen on the manager device, and the management screen shows M user icons corresponding to the M user devices.

15. The remote management system of claim 13, wherein the manager device executes the remote management program in the host device so as to add, cancel or modify user accounts of the N user devices associated with the main application.

16. The remote management system of claim 13, wherein the manager device executes the remote management program in the host device so as to login or logout at least one of the M user devices from the main application.

17. The remote management system of claim 16, wherein the remote management program is triggered to login or logout at least one of the M user devices from the main application after a predetermined time.

18. The remote management system of claim 13, wherein the manager device executes the remote management program in the host device so as to transmit a message, a file and/or an accessory application from the host device to at least one of the M user devices.

19. The remote management system of claim 18, wherein if the accessory application is a desktop captured application, the desktop captured application captures desktop image (s) of at least one of the M user devices and sends the desktop image (s) back to the host device for the manager device to access.

20. The remote management system of claim 19, wherein the desktop captured application updates the desktop image(s) of at least one of the M user devices stored in the host device every a predetermined time.

21. The remote management system of claim 13, wherein the manager device executes the remote management program in the host device so as to terminate an accessory application and/or a web page executed in the host device by at least one of the M user devices.

22. The remote management system of claim 21, wherein once a number of accessory applications executed in the host device by at least one of the M user devices exceed a predetermined value, the remote management program terminates an exceeding number of accessory applications.

23. The remote management system of claim 21, wherein once an executing time of the accessory application executed in the host device by at least one of the M user devices exceeds a predetermined value, the remote management program terminates the accessory application.

24. The remote management system of claim 21, wherein once the accessory application executed in the host device by at least one of the M user devices is not allowed to be executed, the remote management program terminates the accessory application.
